(19) United States
(12) Patent Application Publication
(10) Pub. No.: US 2025/0021111 A1
(43) Pub. Date: Jan. 16, 2025

(54) COORDINATED DRONE OPERATION

(71) Applicant: UAVPatent Corp., Carson City, NV (US)

(72) Inventors: Allan EVANS, San Juan, PR (US); George MATUS, Salt Lake City, UT (US)

(73) Assignee: UAVPatent Corp., Carson City, NV (US)

(21) Appl. No.: 18/712,786

(22) PCT Filed: Dec. 3, 2022
(86) PCT No.: PCT/US2022/051754

§ 371 Date: May 23, 2024

Related U.S. Application Data
(60) Provisional application No. 63/264,943, filed on Dec. 4, 2021.

(51) Int. Cl. G05D 1/69; G05D 1/667; G05D 105/28; G05D 109/25

(52) U.S. Cl. CPC G05D 1/69; G05D 1/667; G05D 2105/28; G05D 2109/254

(57) ABSTRACT

A UAV system comprises a plurality of drones capable of communicating with each other to conduct a coordinated maneuver of a pay load coupled to the plurality of drones. A first drone may detect a change in a payload characteristic of the payload. The first drone may send or receive a communication, wherein the communication concerns an adjustment to be made to a drone characteristic of the first drone in response to the change in the payload characteristic. The first drone may adjust the drone characteristic in accordance with the communication.

### BACKGROUND

There are several ways to lift and move payloads using aerial vehicles. For example, a helicopter flown by a pilot can be used to lift a payload and transport it from one location to another. Another option is to use a remotely-piloted aircraft or vehicle that is controlled by one or more operators that are not within the vehicle (e.g., a UAV). In either scenario, the lifting capabilities and other characteristics of the aircraft limit the maximum weight and, often, physical dimensions of the payload that can be lifted.

When the size of the payload, or the maximum size of the payload, to be moved is known ahead of time, it may be possible to select an aircraft capable of lifting that payload. In some circumstances, however, it may be difficult or impossible to use a single aircraft to move a payload (e.g., due to unavailability or cost of an aircraft capable of handling the entire payload, environmental or operational considerations that prevent the use of the capable aircraft, etc.). Moreover, when the payload size can vary, selection of an aircraft that is capable of lifting and moving payload of the maximum possible size is inefficient (e.g., costly, environmentally unfriendly, etc.) because, for smaller payloads, the aircraft being used is overly capable.

When a payload is larger than the capability of a single aircraft and cannot be divided so as to be lifted/transported via multiple lift operations, multiple aircraft can be used to provide additional lifting capabilities. Traditionally, however, the use of multiple aircraft to lift a payload has required at least one pilot or remote operator per aircraft, with each aircraft operating independently of other aircraft to maneuver the payload. Successful implementation of this lifting configuration requires highly skilled pilots or remote operators. Moreover, the cost associated with the operation may be significant due to the use of multiple aircraft and corresponding operators. In addition, the need for coordinated operation of multiple aircraft that are in close proximity to one another and are coupled to a single payload increases risk. The pilots or operators of each aircraft must coordinate their actions not only to lift the payload, but also to work with the other pilots or operators to successfully maneuver the payload while maintaining safe separation from other aircraft. The complexity of providing safe operation increases significantly with each additional aircraft used for the operation. Thus, this approach is expensive, risky, and not scalable beyond a few aircraft.

Accordingly, there is a need for improvements.

### SUMMARY

This summary represents non-limiting embodiments of the disclosure.

In some aspects, the techniques described herein relate to an unmanned aerial vehicle (UAV) system, including: a plurality of drones capable of communicating with each other to conduct a coordinated maneuver of a payload coupled to the plurality of drones, the plurality of drones including a first drone configured to: detect a change in a payload characteristic of the payload; send or receive a communication, wherein the communication concerns an adjustment to be made to a drone characteristic of the first drone in response to the change in the payload characteristic; and adjust the drone characteristic in accordance with the communication.

In some aspects, the payload characteristic is one or more of a center of gravity, an orientation, a weight, a dimension, a shape, or an oscillation frequency.

In some aspects, the drone characteristic includes one or more of a thrust, a power setting, an orientation, a speed, a direction, an altitude, an attitude, a propeller speed, a propeller orientation, a position relative to the payload, a position relative to a second drone, a connection to the payload, an attachment point on or of the payload, a communication frequency, or a communication technology.

In some aspects, the communication is over one or more of Bluetooth, Wi-Fi, infrared, radio-frequency (RF), a wireless connection, or a wired connection.

In some aspects, the plurality of drones further includes a second drone configured to communicate with the first drone, and the communication is to or from the second drone.

In some aspects, the communication is to the second drone, and the first drone is further configured to: receive an acknowledgment from the second drone; and adjust the drone characteristic of the first drone after receiving the acknowledgment from the second drone.

In some aspects, the communication indicates an implementation delay, and the first drone is further configured to: delay the adjustment of the drone characteristic of the first drone until the implementation delay has elapsed.

In some aspects, the communication instructs the second drone to adjust at least one drone characteristic of the second drone.

In some aspects, the communication is to the second drone, and the first drone is further configured to: delay the adjustment of the drone characteristic until a specified amount of time has elapsed. In some aspects, the communication indicates the specified amount of time.

In some aspects, the communication is from the second drone, and the first drone is further configured to: send an acknowledgment to the second drone; and adjust the drone characteristic after sending the acknowledgment to the second drone.

In some aspects, the communication is from the second drone, and the communication instructs the first drone to wait for a specified amount of time before adjusting the drone characteristic.

In some aspects, the techniques described herein relate to a UAV system, further including a command center configured to communicate with the first drone, and wherein the communication is to or from the command center.

In some aspects, the communication is to the command center, and the first drone is further configured to: receive an acknowledgment from the command center; and adjust the drone characteristic after receiving the acknowledgment from the command center.

In some aspects, the communication indicates an implementation delay, and the first drone is further configured to: delay the adjustment of the drone characteristic until the implementation delay has elapsed.

In some aspects, the techniques described herein relate to a UAV system, further including a second drone configured to communicate with the first drone, and wherein the communication conveys information to the command center regarding an adjustment to at least one drone characteristic of the second drone.

In some aspects, the at least one drone characteristic of the second drone includes at least one of a thrust, a power setting, an orientation, a speed, a direction, an altitude, an attitude, a propeller speed, a propeller orientation, a position relative to the payload, a position relative to a second drone, a connection to the payload, a connection point of the payload, a communication frequency, or a communication technology.

In some aspects, the communication is to the command center, and the first drone is further configured to: delay the adjustment of the drone characteristic until a specified amount of time has elapsed. In some aspects, the communication indicates the specified amount of time.

In some aspects, the command center is configured to send the communication, and the first drone is further configured to: send an acknowledgment to the command center; and adjust the drone characteristic after sending the acknowledgment to the command center.

In some aspects, the command center is configured to send the communication, and the communication instructs the first drone to wait for a specified amount of time to elapse before adjusting the drone characteristic, and the first drone is further configured to: wait for the specified amount of time to elapse before adjusting the drone characteristic.

In some aspects, the drone characteristic is a first drone characteristic, and the command center is configured to send the communication, and the plurality of drones further includes a second drone, and the communication instructs the first drone to instruct the second drone to make an adjustment to a second drone characteristic of the second drone in response to the change in the payload characteristic, and the first drone is further configured to: communicate with the second drone regarding the adjustment to the second drone characteristic, and the second drone is configured to: communicate with the first drone, and adjust the second drone characteristic in accordance with a message to or from the first drone.

In some aspects, the second drone is further configured to: send a confirmation to the first drone, the confirmation acknowledging the adjustment to the second drone characteristic, and the first drone is further configured to: notify the command center that the second drone acknowledged the adjustment to the second drone characteristic.

In some aspects, the second drone characteristic includes one or more of a thrust, a power setting, an orientation, a speed, a direction, an altitude, an attitude, a propeller speed, a propeller orientation, a position relative to the payload, a position relative to the first drone, a connection to the payload, a connection point of the payload, a communication frequency, or a communication technology.

In some aspects, the command center is configured to send the communication over a first wireless network, and the first drone is configured to communicate with the second drone regarding the adjustment to the second drone characteristic over a second wireless network. In some aspects, the first wireless network includes a Wi-Fi or cellular network, and the second wireless network uses at least one of infrared, optical, Bluetooth, or radio-frequency communication.

In some aspects, the techniques described herein relate to a non-transitory computer-readable medium including instructions that, when executed, cause a first drone to: detect a change in a payload characteristic of a payload coupled to the first drone; send or receive a communication, wherein the communication concerns an adjustment to be made to a drone characteristic of the first drone in response to the change in the payload characteristic; and adjust the drone characteristic in accordance with the communication.

In some aspects, the payload characteristic is one or more of a center of gravity, an orientation, a weight, a dimension, a shape, or an oscillation frequency.

In some aspects, the drone characteristic is one or more of a thrust, a power setting, an orientation, a speed, a direction, an altitude, an attitude, a propeller speed, a propeller orientation, a position relative to the payload, a position relative to a second drone, a connection to the payload, a connection point of the payload, a communication frequency, or a communication technology.

In some aspects, the communication is over one or more of Bluetooth, Wi-Fi, infrared, radio-frequency (RF), a wireless connection, or a wired connection.

In some aspects, the communication is to or from a second drone.

In some aspects, the instructions, when executed, cause the first drone to send the communication to the second drone, and, when executed, the instructions further cause the first drone to: receive an acknowledgment from the second drone; and adjust the drone characteristic after receiving the acknowledgment from the second drone.

In some aspects, the communication indicates an implementation delay, and, when executed, the instructions further cause the first drone to: delay the adjustment of the drone characteristic until the implementation delay has elapsed.

In some aspects, the communication instructs the second drone to adjust at least one drone characteristic of the second drone.

In some aspects, the instructions, when executed, cause the first drone to send the communication to the second drone, and, when executed, the instructions further cause the first drone to: delay the adjustment of the drone characteristic until a specified amount of time has elapsed.

In some aspects, the communication indicates the specified amount of time.

In some aspects, the instructions, when executed, cause the first drone to receive the communication from the second drone, and, when executed, the instructions further cause the first drone to: send an acknowledgment to the second drone; and adjust the drone characteristic after sending the acknowledgment to the second drone.

In some aspects, the instructions, when executed, cause the first drone to receive the communication from the second drone, and the communication instructs the first drone to wait for a specified amount of time before adjusting the drone characteristic.

In some aspects, the communication is to or from a command center.

In some aspects, the instructions, when executed, cause the first drone to send the communication to the command center, and, when executed, the instructions further cause the first drone to: receive an acknowledgment from the command center; and adjust the drone characteristic after receiving the acknowledgment from the command center.

In some aspects, the communication indicates an implementation delay, and, when executed, the instructions further cause the first drone to: delay the adjustment of the drone characteristic until the implementation delay has elapsed.

In some aspects, the communication conveys information to the command center regarding an adjustment to at least one drone characteristic of a second drone.

In some aspects, the instructions, when executed, cause the first drone to send the communication to the command center, and, when executed, the instructions further cause the first drone to: delay the adjustment of the drone characteristic until a specified amount of time has elapsed.

In some aspects, the communication indicates the specified amount of time.

In some aspects, the instructions, when executed, cause the first drone to receive the communication from the command center, and, when executed, the instructions further cause the first drone to: send an acknowledgment to the command center; and adjust the drone characteristic after sending the acknowledgment to the command center.

In some aspects, the instructions, when executed, cause the first drone to receive the communication from the command center, and the communication instructs the first drone to wait for a specified amount of time before adjusting the drone characteristic.

In some aspects, the drone characteristic is a first drone characteristic, and the instructions, when executed, cause the first drone to receive the communication from the command center, and the communication instructs the first drone to instruct a second drone to make an adjustment to a second drone characteristic of the second drone in response to the change in the payload characteristic, and, when executed, the instructions further cause the first drone to: communicate with the second drone regarding the adjustment to the second drone characteristic.

In some aspects, when executed, the instructions further cause the first drone to: confirm to the command center that the second drone confirmed the adjustment to the second drone characteristic.

In some aspects, the second drone characteristic is one or more of a thrust, a power setting, an orientation, a speed, a direction, an altitude, an attitude, a propeller speed, a propeller orientation, a position relative to the payload, a position relative to the first drone, a connection to the payload, a connection point of the payload, a communication frequency, or a communication technology.

In some aspects, the communication from the command center is over a first wireless network, and the communication with the second drone regarding the adjustment to the second drone characteristic is over a second wireless network. In some aspects, the first wireless network includes a Wi-Fi or cellular network, and the second wireless network uses at least one of infrared, optical, Bluetooth, or radio-frequency communication.

In some aspects, the techniques described herein relate to a method performed by a drone lift team including a plurality of drones, the method including: determining a current orientation of a payload; identifying a target orientation for the payload; a first drone of the plurality of drones communicating with a second drone of the plurality of drones regarding at least one maneuver to be performed by the first drone or the second drone to change the current orientation of the payload, the at least one maneuver including at least one of a first maneuver to be executed by the first drone or a second maneuver to be executed by the second drone; the first drone executing the first maneuver; and the second drone executing the second maneuver; wherein, after the first maneuver and after the second maneuver, a modified orientation of the payload is substantially the target orientation.

In some aspects, the at least one maneuver includes a change in at least one of a thrust, a power setting, an orientation, a speed, a direction, an altitude, an attitude, a propeller speed, a propeller orientation, a position relative to the payload, a position relative to a particular drone of the plurality of drones, a connection to the payload, or a connection point of the payload.

In some aspects, the techniques described herein relate to a method, further including: the first drone determining the at least one maneuver.

In some aspects, determining the at least one maneuver is based on at least one of: the current orientation of the payload, a size of the payload, a weight of the payload, a dimension of the payload, a volume of the payload, one or more attachment points on the payload, a capability of the first drone, a capability of the second drone, an aggregate capability of the plurality of drones, a number of available drones in the plurality of drones, a total number of drones in the plurality of drones, a flight path, a topography of a region, a position of an obstacle, a weather condition, an expected change to a characteristic of the payload, a time constraint, an amount of time, or an analysis of a scene.

In some aspects, the techniques described herein relate to a method, further including: the first drone and the second drone cooperating to determine the at least one maneuver.

In some aspects, determining the at least one maneuver is based at least in part on at least one of: the current orientation of the payload, a size of the payload, a weight of the payload, a dimension of the payload, a volume of the payload, one or more attachment points on the payload, a capability of the first drone, a capability of the second drone, an aggregate capability of the plurality of drones, a number of available drones in the plurality of drones, a total number of drones in the plurality of drones, a flight path, a topography of a region, a position of an obstacle, a weather condition, an expected change to a characteristic of the payload, a time constraint, an amount of time, or an analysis of a scene.

In some aspects, the characteristic of the payload includes one or more of: the size of the payload, the weight of the payload, the dimension of the payload, the volume of the payload, a center of gravity of the payload, a shape of the payload, or an oscillation frequency induced by the payload.

In some aspects, cooperating to determine the at least one maneuver includes: the first drone collecting information from the second drone. In some aspects, the information includes an indication of a capability of the second drone, a make of the second drone, a model of the second drone, a battery level of the second drone, a maximum thrust of the second drone, a size of the second drone, or an attachment capability of the second drone.

In some aspects, determining the current orientation of the payload includes at least one drone of the plurality of drones receiving a signal from a command center, the signal conveying the current orientation of the payload. In some aspects, the signal further conveys a current location of the payload. In some aspects, the signal includes at least one of a Bluetooth, Wi-Fi, cellular, Zigbee, radio-frequency, infrared, wireless, or wired signal.

In some aspects, determining the current orientation of the payload includes at least one drone of the plurality of drones receiving a signal from the payload. In some aspects, the signal conveys the current orientation of the payload. In some aspects, determining the current orientation of the payload further includes processing the signal. In some aspects, the signal further conveys a current location of the payload. In some aspects, the signal includes at least one of a Bluetooth, Wi-Fi, cellular, Zigbee, radio-frequency, infrared, wireless, or wired signal.

In some aspects, determining the current orientation of the payload includes at least one drone of the plurality of drones using an on-board component to detect the current orientation of the payload. In some aspects, the on-board component includes an optical camera, a sonar system, a LiDAR system, or a radar system.

In some aspects, identifying the target orientation for the payload includes at least one drone of the plurality of drones receiving a signal from a command center, the signal conveying the target orientation of the payload. In some aspects, the signal further conveys a target location of the payload. In some aspects, the signal includes at least one of a Bluetooth, Wi-Fi, cellular, Zigbee, radio-frequency, infrared, wireless, or wired signal.

In some aspects, identifying the target orientation for the payload includes at least one drone of the plurality of drones receiving a signal from the payload, the signal conveying the target orientation of the payload. In some aspects, the signal further conveys a target location of the payload. In some aspects, the signal includes at least one of a Bluetooth, Wi-Fi, cellular, Zigbee, radio-frequency, infrared, wireless, or wired signal.

In some aspects, identifying the target orientation for the payload includes: analyzing a scene; and determining the target orientation for the payload using a result of analyzing the scene. In some aspects, the scene is represented by a three-dimensional map. In some aspects, analyzing the scene includes accounting for at least one weather condition. In some aspects, the at least one weather condition includes a wind speed or a wind direction. In some aspects, analyzing the scene includes accounting for at least one obstacle in the scene.

In some aspects, determining the target orientation for the payload using the result of analyzing the scene includes accounting for a capability of at least one of the first drone or the second drone.

In some aspects, the first drone of the plurality of drones communicating with the second drone of the plurality of drones regarding the at least one maneuver to be performed by the first drone or the second drone to change the current orientation of the payload includes (a) the first drone sending a first signal to the second drone, (b) the second drone sending a second signal to the first drone, or (c) both (a) and (b). In some aspects, at least one of the first signal or the second signal includes at least one of a Bluetooth, Wi-Fi, cellular, Zigbee, radio-frequency, infrared, wireless, or wired signal.

In some aspects, at least one the first maneuver or the second maneuver is characterized by at least one of a speed, a direction, a thrust, a velocity, an angle, a delay, a start time, a completion time, or a duration.

In some aspects, the target orientation is a rotation of the current orientation about a horizontal axis.

In some aspects, the techniques described herein relate to an unmanned aerial vehicle (UAV) system for manipulating a payload, the UAV system including: a first drone capable of being attached to the payload; a second drone capable of being attached to the payload and configured to communicate with the first drone to conduct a coordinated operation to manipulate the payload; and a third drone capable of being attached to the payload and configured to communicate with the first drone and the second drone, wherein the third drone is configured to: determine that the third drone will replace the first drone during the operation to manipulate the payload, and in response to determining that the third drone will replace the first drone during the operation to manipulate the payload, attach to the payload at a selected attachment point, and wherein the first drone is configured to: determine that the third drone is attached to the payload, and in response to determining that the third drone is attached to the payload, detach from the payload.

In some aspects, the selected attachment point is a an attachment point used by the first drone.

In some aspects, the selected attachment point differs from an attachment point used by the first drone.

In some aspects, the third drone is configured to determine that the third drone will replace the first drone during the operation to manipulate the payload based on a communication received from the first drone. In some aspects, the communication concerns a power level of the first drone.

In some aspects, the third drone is configured to determine that the third drone will replace the first drone during the operation to manipulate the payload based on an observation of a characteristic of the first drone and/or the second drone and/or the payload.

In some aspects, the characteristic is at least one of an altitude, an attitude, or an orientation.

In some aspects, the third drone is configured to use an on-board optical system to make the observation.

In some aspects, the third drone is configured to determine that the third drone will replace the first drone during the operation to manipulate the payload based on a communication received from the second drone. In some aspects, the communication received from the second drone includes an indication of an observation made by the second drone. In some aspects, the observation made by the second drone includes a detected change in a position of the second drone relative to the payload. In some aspects, the observation made by the second drone includes a detected change in a position of the first drone relative to the payload. In some aspects, the observation made by the second drone includes a detected change in a proportion of a weight of the payload being supported by the second drone. In some aspects, the observation made by the second drone includes a detected change in an altitude, attitude, and/or orientation of the first drone, the second drone, and/or the payload.

In some aspects, the techniques described herein relate to a UAV system, further including a command center, and the third drone is configured to determine that the third drone will replace the first drone during the operation to manipulate the payload based on a communication received from the command center.

In some aspects, the first drone is configured to determine that the third drone is attached to the payload based on a signal received from the third drone.

In some aspects, the first drone is configured to determine that the third drone is attached to the payload based on a signal received from the second drone.

In some aspects, the first drone is configured to determine that the third drone is attached to the payload based at least in part on a detected change in a proportion of a weight of the payload being supported by the first drone.

In some aspects, the first drone is configured to determine that the third drone is attached to the payload by detecting a presence of the third drone.

In some aspects, the first drone includes an on-board optical system, and the first drone is configured to detect the presence of the third drone using the on-board optical system.

In some aspects, the techniques described herein relate to a UAV system, further including a command center, and the first drone is configured to determine that the third drone is attached to the payload based on a communication received from the command center.

In some aspects, the first drone is further configured to navigate to a base after detaching from the payload.

In some aspects, the third drone is further configured to: use first flight settings after attaching to the payload at the selected attachment point, and use second flight settings after the first drone has detached from the payload. In some aspects, the first flight settings include a first thrust level, and the second flight settings include a second thrust level, wherein the second thrust level provides more thrust than the first thrust level. In some aspects, the first flight settings include a first thrust direction, and the second flight settings include a second thrust direction, wherein the first thrust direction and the second thrust direction are different.

### BRIEF DESCRIPTION OF THE DRAWINGS

Objects, features, and advantages of the disclosure will be readily apparent from the following description of certain embodiments taken in conjunction with the accompanying drawings in which:

FIG. 1A illustrates an example of a UAV system in accordance with some embodiments.

FIG. 1B illustrates some of the components of an example of a drone of a UAV system in accordance with some embodiments.

FIG. 2 illustrates an example UAV system in accordance with some embodiments.

FIGS. 3A, 3B, and 3C illustrate an example UAV system in accordance with some embodiments.

FIGS. 4A and 4B illustrate an example UAV system in accordance with some embodiments.

FIG. 5 illustrates an example of a UAV system in which multiple drones share a common attachment point on the payload in accordance with some embodiments.

FIGS. 6A, 6B, and 6C illustrate an example in accordance with some embodiments in which a first drone is replaced during the operation by a second drone 105C.

FIG. 6D illustrates a drone attaching to a payload in accordance with some embodiments.

FIG. 6E shows a UAV system after a drone has detached in accordance with some embodiments.

FIG. 7A illustrates a crane that is lifting a payload without assistance from a UAV system.

FIG. 7B illustrates how a UAV system can be used to assist the crane of FIG. 7A in lifting and maneuvering the payload in accordance with some embodiments.

FIG. 8 illustrates an example of how power and/or one or more wired communication channels can be provided by a component being assisted by the drones of a UAV system in accordance with some embodiments.

FIG. 9 is an illustration of a UAV system that includes a command center in accordance with some embodiments.

FIG. 10 is a flow diagram of a method that can be performed by the drones of a UAV system in accordance with some embodiments.

To facilitate understanding, identical reference numerals have been used, where possible, to designate identical elements that are common to the figures. It is contemplated that elements disclosed in one embodiment may be beneficially utilized in other embodiments without specific recitation.

Moreover, the description of an element in the context of one drawing is applicable to other drawings illustrating that element.

### DETAILED DESCRIPTION

The present disclosure relates to the field of unmanned aerial vehicle (UAV) communication technology, and particularly to methods and systems of using multiple UAVs (also referred to herein as “drones”) in a coordinated fashion to accomplish tasks.

Disclosed herein are modular UAV systems and methods that address at least some of the shortcomings described above by allowing a plurality of (i.e., two or more) drones to cooperate with each other to provide scalable, configurable payload lifting, maneuvering, and/or transporting capabilities. As disclosed herein, a modular UAV system uses a plurality of drones that are separately coupled to a payload and operate in coordination with each other to lift and/or maneuver and/or transport the payload. The drones need not be physically connected to each other. Instead, each can be separately attached to a payload, and the drones can coordinate with each other to lift and/or maneuver and/or transport payloads. The collection of drones, which can be referred to as a lift team, can be remotely- and/or autonomously-controlled. For example, the UAV system can include, in addition to the lift team, a command center. Alternatively, the drones can carry out their tasks without any external assistance or involvement.

Each individual drone in a lift team may include, among other things, a power source, one or more rotors, one or more sensors, a transceiver allowing communication with other drones in the lift team and/or an external entity (e.g., a remote pilot), and a control system that enables the individual drone to lift and maneuver a payload in coordination with other drones in the lift team according to the lifting capabilities of the drone.

Depending on the characteristics of the payload to be manipulated (e.g., lifted and/or maneuvered) (e.g., its size, weight, dynamic properties, etc.), the appropriate number of individual drones in the lift team, and their characteristics (e.g., size, power, etc.), may be determined. For example, a person or a computer (e.g., external to the lift team or part of the lift team) may determine that the lift team should include M drones having a first set of characteristics, and N drones having a second set of characteristics, where the first and second sets of characteristics can include any appropriate characteristics, such as, for example, size, weight, power, maneuverability, etc. The appropriate number of drones, and the characteristics of the drones selected for the lift team, may also depend, for example, on environmental restrictions (e.g., limits on the volume of space in which the drones can operate). The drones selected for the lift team may then determine or be provided an appropriate configuration (e.g., attachment points, relative positions, etc.) to lift a payload.

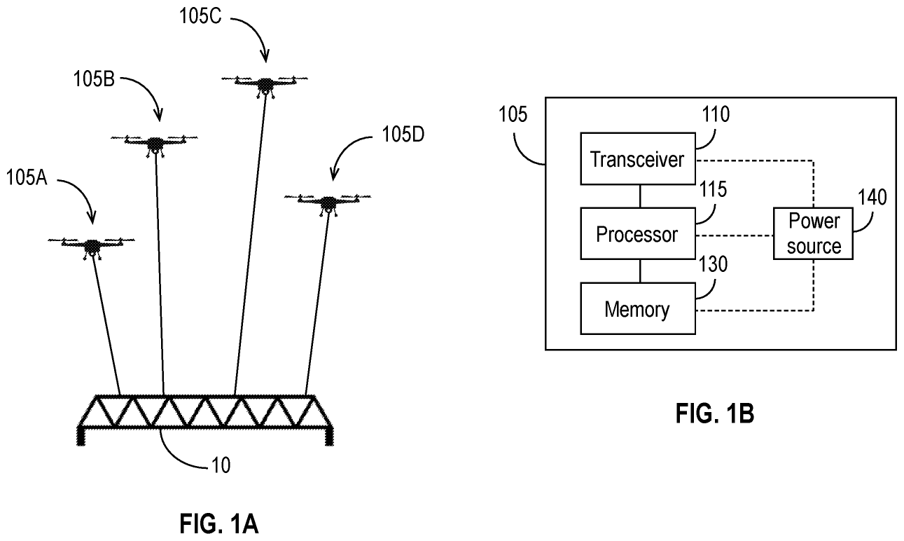

FIG. 1A illustrates an example of a UAV system 100 in accordance with some embodiments. The UAV system 100 example illustrated in FIG. 1A includes a lift team that includes four drones, namely, the drone 105A, the drone 105B, the drone 105C, and the drone 105D. It is to be appreciated that four drones 105 are shown to illustrate the concepts described herein, and that more or fewer than four drones 105 can be used in a UAV system 100. In the example of FIG. 1A, the drone 105A, the drone 105B, the drone 105C, and the drone 105D are attached to an object, the payload 10. FIG. 1A illustrates a truss as the payload 10, but it is to be appreciated that other types of objects or collections of objects can be the payload 10. By working together (e.g., by communicating directly with each other, by communicating with each other through a central command (e.g., an external entity), or both) the drones 105 in the UAV system 100 can set their thrust vectors to collectively lift the payload 10. For example, the drone 105A can determine, in cooperation with the drone 105B, and/or the drone 105C, and/or the drone 105D that it should fly in a first direction at a first power level (e.g., thrust). Similarly, the drone 105B can determine, in cooperation with the drone 105A, and/or the drone 105C, and/or the drone 105D that it should fly in a second direction at a second power level. Likewise, the drone 105C can determine, in cooperation with the drone 105B, and/or the drone 105A, and/or the drone 105D that it should fly in a third direction at a third power level, and the drone 105D can determine, in cooperation with the drone 105A, and/or the drone 105B, and/or the drone 105C that it should fly in a fourth direction at a fourth power level The first, second, third, and fourth power levels can all be different, or two or more of them can be the same. Similarly, the first, second, third, and fourth directions can all be different, or two or more of them can be the same.

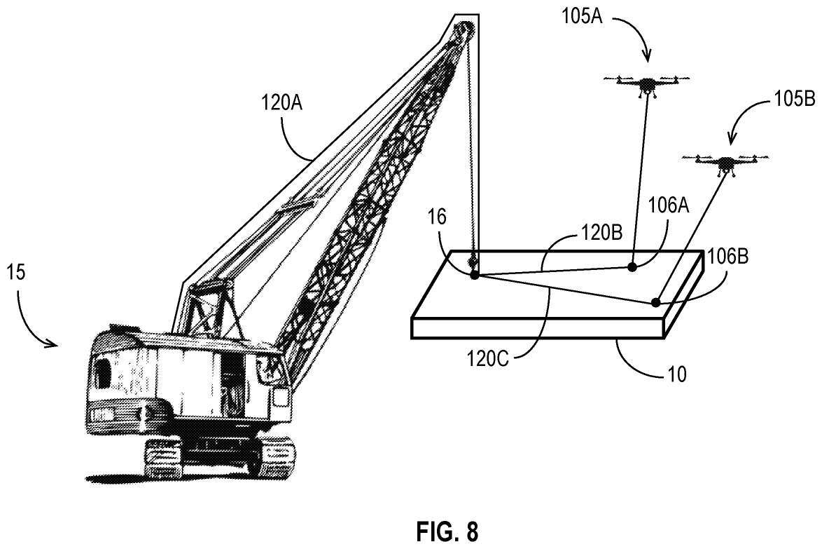

FIG. 1B illustrates some of the components of an example of a drone 105 of a UAV system 100 in accordance with some embodiments. The drone 105 example shown in FIG. 1B may correspond to any of the drones 105 illustrated herein (e.g., the drone 105A, the drone 105B, the drone 105C, the drone 105D shown in FIG. 1A). The drone 105 may include a transceiver 110 that allows wireless communication via, e.g., Wi-Fi, Bluetooth, Zigbee, cellular, or any other wireless communication protocol or technique. Alternatively, or in addition, the transceiver 110 may allow the drone 105 to communicate to external entities (e.g., other drones 105, etc.) via a wired connection (e.g., USB, Ethernet, powerline communication, etc.). Such an example is described and illustrated in the context of FIG. 8 below. The transceiver 110 may be configured to allow the drones 105 to communicate with (i.e., transmit signals to and receive signals from) each other and/or an external entity (e.g., a pilot, controller, command center, etc.) and/or other components that may be involved in a lift/maneuver operation (e.g., a crane, as discussed further below).

As shown in FIG. 1B, the drone 105 may include at least one processor 115 configured to execute software to prompt the drone 105 to perform the functions described herein. The software may be stored in a memory 130 (e.g., a non-transitory computer-readable storage medium) included in the drone 105 and communicatively coupled to the at least one processor 115. The software may be stored on any suitable non-transitory computer-readable medium (e.g., a data storage device, flash memory, random-access memory, read-only memory, on-board processor memory, etc.) as machine-executable instructions that, when executed by the at least one processor 115, result in the drone 105 performing the techniques described herein.

The drones 105 may also include a power source 140. The power source 140 may comprise, for example, one or more rechargeable batteries. The power source 140 may be coupled to any component of the drone 105 that requires power (e.g., the transceiver 110, the at least one processor 115, the memory 130, etc.). The power source 140 may be rechargeable and/or replaceable.

It is to be appreciated that the drone 105 includes additional components that are not illustrated in FIG. 1B. For example, FIG. 1B does not illustrate propeller(s), an enclosure, cables or other components used to connect the drone 105 to the payload 10, etc.

As mentioned above, the drones 105 making up a lift team need not be identical to each other. For example, the drones 105 of a UAV system 100 may have different lifting and/or maneuvering capabilities. As a specific example, referring to FIG. 1A, one or more of the selected drones 105 (e.g., drone 105A) may be more or less powerful than one or more of the other selected drones 105 (e.g., drone 105B, drone 105C, or drone 105D). Similarly, the drones 105 of a UAV system 100 may be of different sizes, makes, or models. Accordingly, the drones 105 do not need to be the same vehicle or vehicle type.

In some embodiments, a pool of candidate drones 105 is provided information about a payload 10 to be moved, and a subset of the pool of candidate drones 105 is selected as the lift team. The selection can be autonomously made by one or more of the candidate drones 105 (e.g., by communicating with other drones 105 in the pool regarding their capabilities and the characteristics of the payload 10 to be lifted/moved), or it can be made by an external entity (e.g., a controller communicatively coupled to one or more drones 105 in the pool, a human being, a computer, etc.).

In some embodiments, the drones 105 in a UAV system 100 coordinate entirely among themselves and are not controlled by an external entity, such as a pilot. In some such embodiments, one of the drones 105 has a primary role in the coordination, and the rest of the drones 105 have secondary roles. The drone 105 that has a primary role may, for example, entirely direct the actions of the other drones 105 in the UAV system 100. In such an embodiment, the drone 105 with the primary role can be said to have full control of the UAV system 100.

In other embodiments in which the drones 105 in a UAV system 100 coordinate entirely among themselves and are not controlled by an external entity, a drone 105 with a primary role can allow the drones 105 with secondary roles to operate without interference from the drone 105 with a primary role unless or until there is a conflict. For example, in such embodiments, the drone 105 with a primary role can monitor communications from and among the rest of the drones 105 in the UAV system 100 and resolve detected conflicts between other drones 105 in the UAV system 100. As a specific example, a UAV system 100 may include a drone 105A with a primary role, a drone 105B with a secondary role, and a drone 105C with a secondary role. The drone 105B may express an intention to take a particular action that conflicts in some way with an expressed intention to take another action by the drone 105C. After detecting the conflict, the drone 105A may override one of both of the drone 105B and/or drone 105C by directing one or both of them not to perform their intended actions, or by instructing one or both of the drone 105B and/or drone 105C to perform modified actions. Additionally or alternatively, the drone 105A may instruct one or both of the drone 105B and/or drone 105C to delay performing the intended action.

In still other embodiments in which the drones 105 in a UAV system 100 coordinate entirely among themselves and are not controlled by an external entity, all of the drones 105 have equal status, and no single drone 105 has the ability to override or control any other drone 105. In such embodiments, the drones 105 negotiate with each other to avoid conflicts that might jeopardize a mission or flight.

In some embodiments, one or more of the drones 105 are configured to receive commands from an external entity, such as a pilot, and to communicate with other of the drones 105 to carry out the command. For example, a human pilot on the ground may want a plurality of drones 105 to pick up a payload 10 and move it to a different location. The pilot may have access to a wired or wireless transceiver that allows him to send the command in some format (e.g., one or more instructions) to one or more of the drones 105. The instruction(s) can be high-level (e.g., “pick up the payload 10 and move it to this location,” leaving the details of the configuration up to the drones 105) or lower-level (e.g., identifying which drones 105 to use to move the payload 10 to a different location, identifying a desired orientation of the payload 10 in flight, specifying attachments points for one or more of the drones 105, etc.).

In some embodiments, each of the drones 105 is categorized as either a leader or a follower. In some embodiments, the status of a drone 105 as a leader or a follower is configurable (e.g., drones 105 initially made leaders may be made followers and/or followers may be made leaders). For example, a human pilot or other external entity may have access to a mechanism to change the category of one or more drones 105. The mechanism may be, for example, a hardware switch (e.g., a toggle switch, a slide switch, etc.), a software reconfiguration (e.g., execution of more or less executable code at startup), or a combination of the two. In some embodiments, an external entity transmits a command to a particular drone to change its category (e.g., from leader to follower or vice versa).

In some embodiments, all of the drones 105 have equal status, referred to herein as peer status. In this case, the drones 105 make decisions collectively and in cooperation with each other.

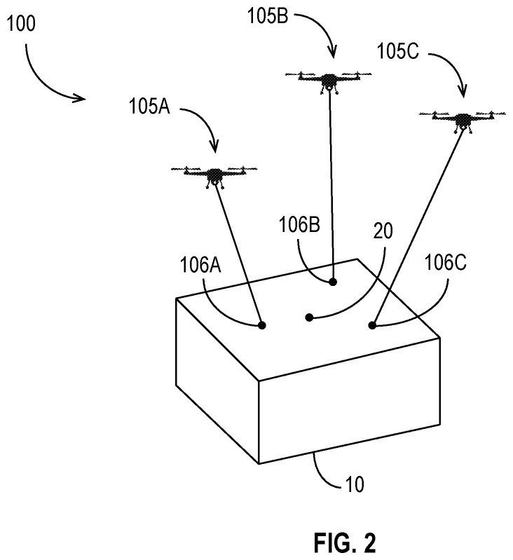

FIG. 2 illustrates an example UAV system 100 that includes a drone 105A, a drone 105B, and a drone 105C. The drone 105A is attached to the payload 10 at a first attachment point 106A, the drone 105B is attached to the payload 10 at a second attachment point 106B, and the drone 105C is attached to the payload 10 at a third attachment point 106C. The drones 105 can be attached in any suitable way (e.g., via designated attachment points 106 (e.g., hooks, rings, etc.) or by using magnetics or any other adhesion processes (e.g., vacuum, suction, adhesive, etc.)) to any suitable surface or feature of the payload 10. The attachment points 106 can be selected by an external entity (e.g., a person or an external computer or system), or they can be selected by one or more of the drones 105 in a lift team (e.g., a leader, a follower, a peer, etc.). In some embodiments, each of the drones 105 in a UAV system 100 can determine its attachment point 106 either with or without coordination with other drones 105 in the UAV system 100. The selected attachment points 106 may be determined as absolute coordinates (e.g., a ring at a known position on the payload 10, a flat or smooth portion of the payload 10 at a particular position on the payload 10, etc.) or relative to a known position on the payload 10 or another selected attachment point 106 (e.g., a ring a distance D away from another ring used by another drone 105, a flat or smooth portion of the payload 10 a distance D away from another flat or smooth portion of the payload 10, etc.).

The selected attachment points 106 may account for any characteristic of the payload 10 and/or the drones 105 in the UAV system 100. For example, the attachment points 106 can account for the center of gravity of the payload 10. As another example, the attachment points 106 can account for the characteristics of the drones 105 in the UAV system 100 (e.g., any of maximum power, battery life, size, propeller span, etc.).

In some embodiments, the drones 105 perform an assessment procedure through which they sense characteristics of the payload 10 (e.g., using on-board sensors, such as cameras). The assessment procedure can be performed before or after the drones 105 have been attached to the payload 10 (e.g., at attachment points 106 they selected autonomously or that were selected for them). For example, the drones 105 can select initial attachment points 106 and initial thrust vectors (e.g., power and direction) and sense how the payload 10 moves as a result of the initial attachment points 106 and initial thrust vectors. The drones 105 can then adjust their attachment points 106 and/or thrust vectors to move the payload 10 in a desired way. For example, after detecting how the payload 10 moves or its weight after lifting the payload 10, the drones 105 may determine that one or more of the attachment points 106 need to be adjusted. As another example, the drones 105 can determine that the attachment points 106 points are suitable, but one or more thrust vectors should be adjusted (e.g., one or more of the drones 105 need to change direction or thrust power). Thus, the data allows the drones 105 to select and/or optimize their trajectories to move the payload 10 in a particular way (e.g., efficiently, safely, with a particular orientation, etc.).

The drones 105 in a UAV system 100 can also determine and use a configuration (e.g., number and/or characteristics of the drones 105, attachment points 106, etc.) and settings (e.g., power, direction, etc.) to meet constraints (e.g., to maximize collective battery life, etc.). For example, the drones 105 may determine (e.g., after attempting to move the payload 10 and determining that the configuration is ineffectual or should be further optimized) that a different selection of drones 105 as the lift team, or different attachment points 106 for the current selection of drones 105, would be preferable to move the payload 10.

The drones 105 in the UAV system 100 may be controlled in a variety of ways. For example, the drones 105 in the UAV system 100 can communicate directly with each other to lift the payload 10 and move it in a desired way (e.g., to change its orientation, to move it to another location, etc.). As another example, an external entity (e.g., a person or a computer) can control at least some aspect of the UAV system 100 remotely. The drones 105 may be manually controlled by an eternal entity (e.g., a person or a programmed control system) throughout a maneuver, or the drones 105 in the lift team may autonomously control themselves throughout the maneuver, or a combination of manual and autonomous control can be used, with manual control at some points and autonomous control during others. For example, a pilot or operator can send to one or more drones 105 in a UAV system 100 a command (e.g., a high-level intention) such as “Lift the payload 10 over the building and place it at the position X.” The drones 105 in the UAV system 100 can then communicate amongst themselves and cooperate to carry out the instruction safely and efficiently.

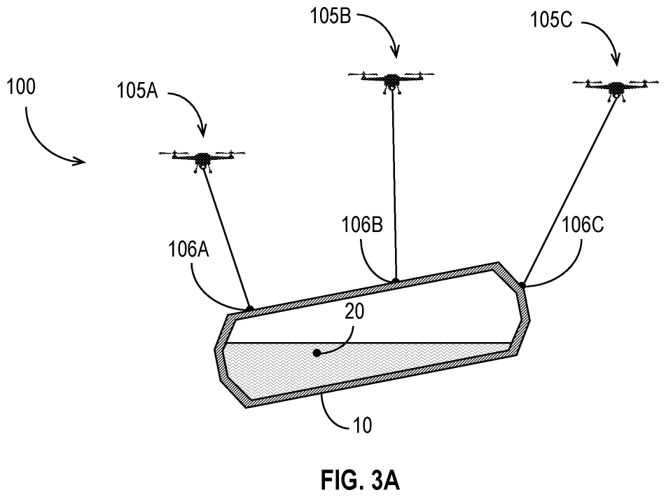

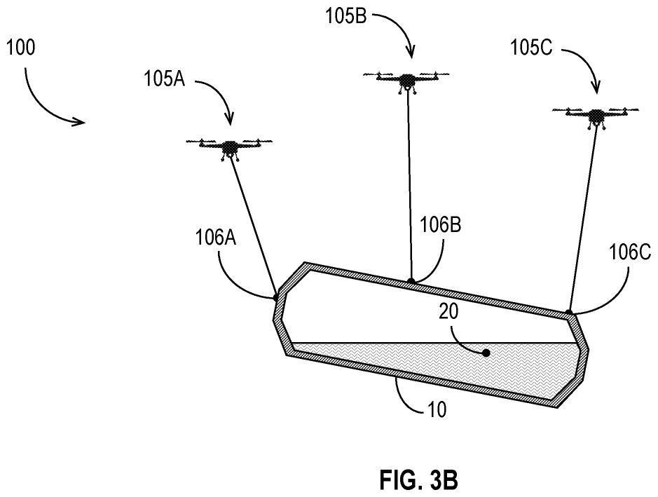

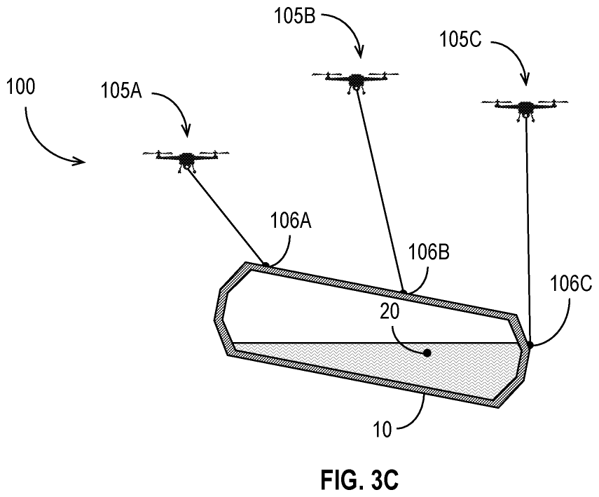

In some applications, the drones 105 in a UAV system 100 may transport a payload 10 that has one or more characteristics, such as a center of gravity, that can change during the mission. FIGS. 3A, 3B, and 3C illustrate an example UAV system 100 with three drones 105 attached to a payload 10, which is illustrated as a tank that is partially filled with liquid. Specifically, the drone 105A is attached to the payload 10 at a first attachment point 106A, the drone 105B is attached to the payload 10 at a second attachment point 106B, and the drone 105C is attached to the payload 10 at a third attachment point 106C. FIG. 3A shows the orientation of the payload 10 at a first point in time, and each of FIGS. 3B and 3C shows the payload 10 after the center of gravity 20 has shifted. Because the drone 105A, drone 105B, and drone 105C are able to communicate with each other (directly and/or through a centralized control), they can detect and promptly adapt to the shift in the center of gravity 20 (and/or other changes caused by the payload 10 having dynamic characteristics) to maintain stability in the air and along the lift/transport path. In some embodiments, as shown in the example of FIG. 3B, the drones 105 are able to modify their attachment points 106 to compensate for the change in the position of the center of gravity 20. In some embodiments, as shown in the example of FIG. 3C, the drones 105 can modify their thrust vectors (e.g., direction or power) to compensate for the change in the position of the center of gravity 20. In some embodiments, some or all of the drones 105 in a UAV system 100 can modify both their attachment points 106 and their thrust vectors. Some or all of the drones 105 may be able to modify other aspects of their configurations. The examples provided herein are not intended to be limiting.

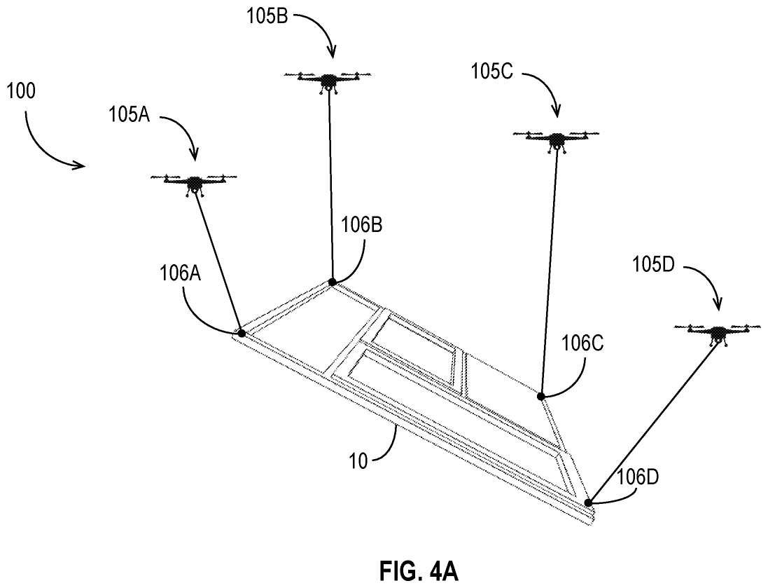

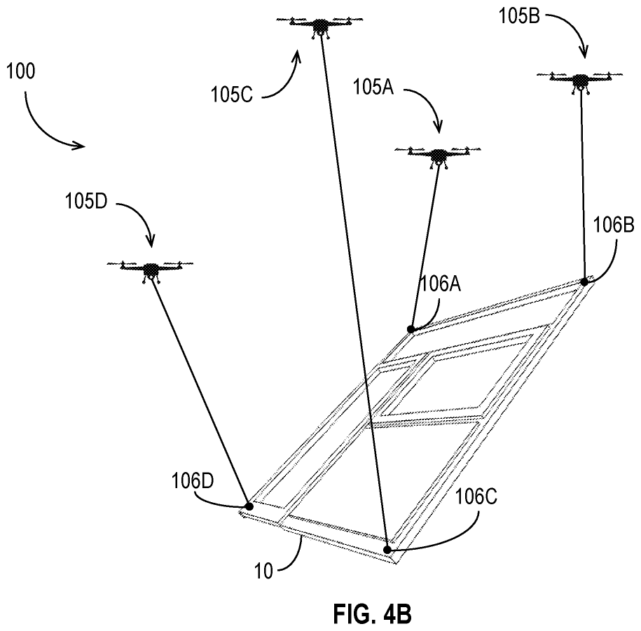

In some embodiments, the drones 105 of a UAV system 100 acting in coordination can manipulate the position and/or orientation of the payload 10. FIGS. 4A and 4B illustrate an example in accordance with some embodiments. For example, the payload 10 could be a wall segment that is initially in a first orientation on the ground (e.g., flat) or in the process of being lifted (e.g., as shown in FIG. 4A). By coordinating with each other, the drones 105 can attach themselves (or be attached) to the payload 10 and then move it into a second orientation in flight (e.g., move a wall segment into a different orientation, as shown in FIG. 4B) and/or in an orientation suitable to put the payload 10 in place (e.g., move the wall segment shown in FIGS. 4A and 4B into a vertical position for placement). Although FIGS. 4A and 4B illustrate four drones 105 (namely. the drone 105A attached at the first attachment point 106A, the drone 105B attached at the second attachment point 106B, the drone 105C attached at the third attachment point 106C, and the drone 105D attached at the third attachment point 106D), it is to be appreciated that the UAV system 100 can include any number of drones 105 attached to the payload 10 at any suitable attachment points 106. As discussed elsewhere herein, each of the drones 105 can have a unique one of the attachment points 106, or there may be fewer attachment points 106 than drones 105 such that multiple drones 105 share the same attachment point 106. There may be as few as one attachment point 106.

Using similar or the same techniques, the drones 105 in a UAV system 100 can adjust the orientation of a payload 10 and/or find a suitable, convenient, or optimum carrying position for the payload 10 in environmental situations that might otherwise cause instability (e.g., high winds, gusty winds, etc.). For example, if the drones 105 encounter strong winds from the west and are moving a wall segment at the payload 10, they can adjust the orientation of the wall segment so that its profile toward west is small or minimized. Similarly, the drones 105 can adjust to other changes to the payload 10 that might occur during flight (e.g., changes in the center of gravity 20, weight of the payload 10, etc.). For example, if the total weight of the payload 10 can change during flight (e.g., if the payload 10 can fill with water, or soak up water, and it is raining during the lift/transport operation), the drones 105 can adjust to the increased weight (e.g., by increasing their thrust and/or changing their directions) during the mission.

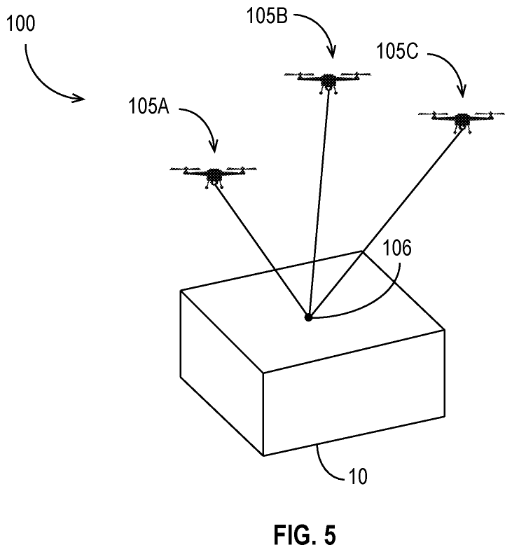

The drones 105 can be attached (or attach themselves to) the payload 10 in any suitable way and at any suitable attachment points 106. The drones 105 in a UAV system 100 can have different attachment points 106, or two or more drones 105 can share an attachment point 106. FIG. 5 illustrates an example of a UAV system 100 in which the drone 105A, drone 105B, and drone 105C share a common attachment point 106 on the payload 10. In the illustrated configuration, the drones 105 can configure themselves such that their vectors (e.g., power and direction) prevent the drones 105 from colliding in flight when they share an attachment point 106. During the operation, the drones 105 can communicate with each other to update their thrust vectors to ensure they maintain sufficient separation from each other and from other objects or obstacles that might otherwise cause collisions while still carrying out the mission.

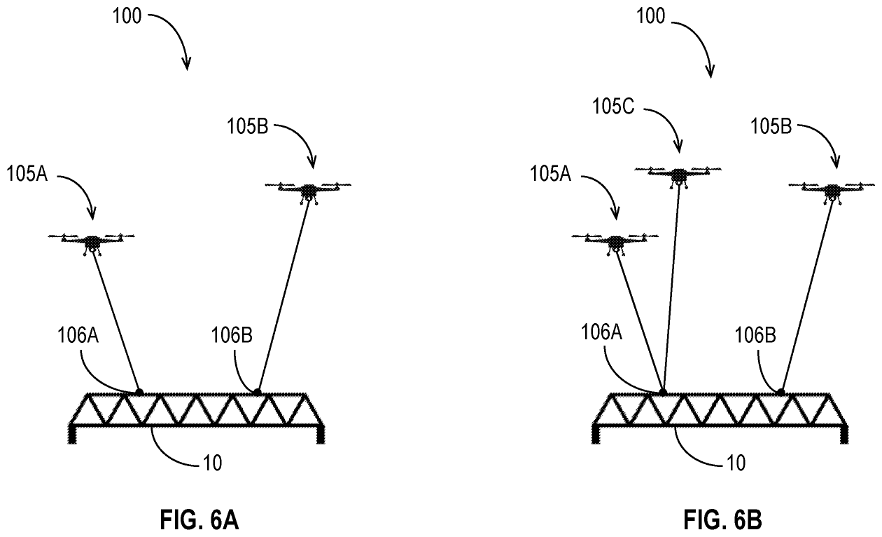

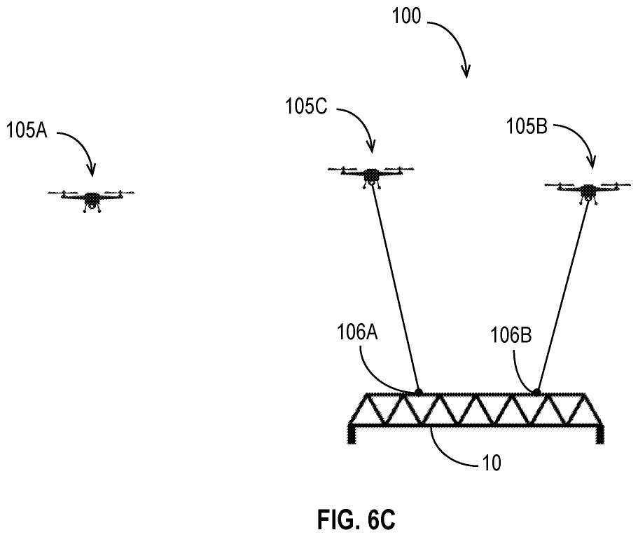

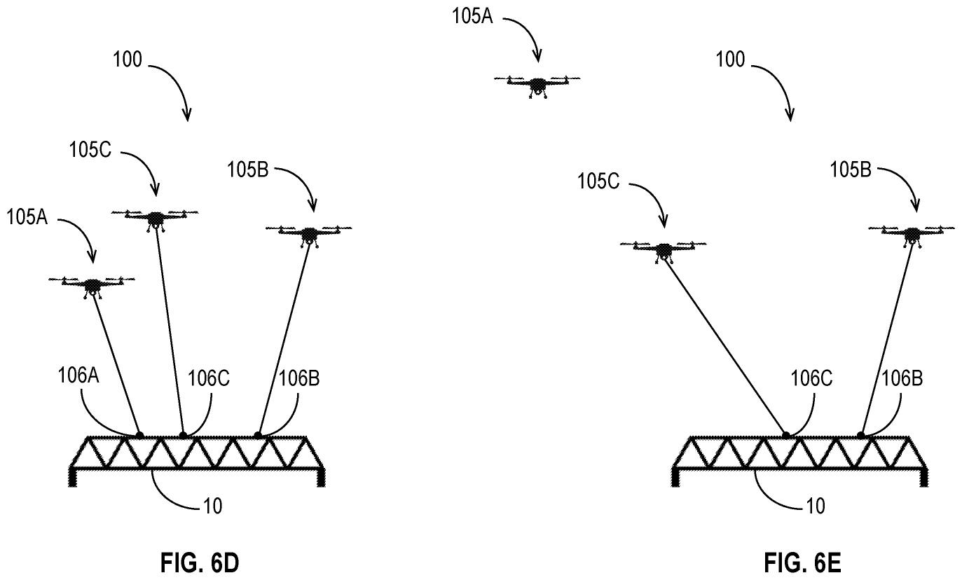

In some embodiments, the drones 105 in a UAV system 100 can attach to and/or detach from a payload 10 during an operation (e.g., while the payload 10 is being moved). Such embodiments can allow, for example, drones 105 that are running low on power to be replaced by drones 105 with fresh batteries to avoid a significant disruption in the mission to move the payload 10. FIGS. 6A, 6B, and 6C illustrate an example in accordance with some embodiments in which a drone 105A (the “old” or “depleted” drone) is replaced during the operation by a drone 105C (the “new” or “fresh” drone). In FIG. 6A, the drone 105A is attached to the payload 10 (shown as a truss) at a first attachment point 106A, and the drone 105B is attached to the payload 10 at a second attachment point 106B. As shown in FIG. 6B, the replacement (“new”) drone 105C can attach to the payload 10 at the first attachment point 106A. As shown in FIG. 6C, the drone 105A can then detach from the payload 10 (e.g., to fly to a base for recharging), leaving the drone 105C in its place to continue the mission. The thrust vector of the drone 105C can be a first thrust vector while the drone 105A is still attached to the payload 10 (FIG. 6B) and a second thrust vector after the drones 105 detaches from the payload 10.

As an alternative to the replacement (“new”) drone 105C attaching to the payload 10 at the same attachment point 106 as used by the drone 105A, the drone 105C can attach to the payload 10 at a different attachment point 106. FIGS. 6D and 6E show an example of a UAV system 100 in which a replacement drone 105C replaces a drone 105A by attaching to the payload 10 at a different attachment point 106. FIG. 6D illustrates the drone 105C attaching to the payload 10 at a third attachment point 106C, which is different from the first attachment point 106A. FIG. 6E shows the UAV system 100 after the drone 105A has detached (e.g., to fly to a base for recharging). The thrust vector of the drone 105C can be a first thrust vector while the drone 105A is still attached to the payload 10 (FIG. 6D) and a second thrust vector after the drones 105 detaches from the payload 10 (FIG. 6E).

Thus, the UAV system 100 can be used to manipulate a payload 10 using a lift team of drones 105. The drones 105 can include, for example, a drone 105A and a drone 105B capable of being attached to the payload 10 (as shown in FIG. 6A, for example). As described herein, the drone 105A and the drone 105B can be configured to communicate with each other so as to conduct a coordinated operation to manipulate the payload 10 (e.g., to lift and/or reorient and/or transport the payload 10). The drones 105 can also include a drone 105C that is also capable of being attached to the payload 10 (e.g., at the same attachment point 106 as either the drone 105A or the drone 105B or one or more different attachment points 106). The drone 105C can be configured to determine that it will replace, for example, the drone 105A during the operation to manipulate the payload 10. In response to determining that it will replace the drone 105A, the drone 105C can attach to the payload 10 at a selected attachment point 106, which can be the same as (FIG. 6B) or different from (FIGS. 6D and 6E) the first attachment point 106A used by the drone 105A. The drone 105A can then determine that the drone 105C is attached to the payload 10 and, in response, detach from the payload 10. After detaching from the payload 10, the drone 105A may be configured to fly (navigate) to a base to, for example, receive maintenance or charge a rechargeable power source (e.g., a battery).

The drone 105C can determine that it is to replace the drone 105A in any suitable way. For example, the drone 105A can send the drone 105C a communication (e.g., via a wireless signal) to notify the drone 105C that it will replace the drone 105A. The drone 105A can send the communication, for example, in response to the level of its power source (e.g., battery) dropping below a threshold level, or upon detecting a problem with its software or hardware, or for any other reason.

The drone 105C can alternatively, or additionally, determine that it is to replace the drone 105A by observing the operation being conducted to manipulate the payload 10. For example, the drone 105C can include on-board equipment (e.g., an optical system such as a camera, sensors, a radar system, a LiDAR system, etc.) that allow it to observe the operation and to detect that it should replace the drone 105A. For example, the drone 105C could monitor the drone 105A, the drone 105B, and/or the payload 10 to detect, for example, changes in altitude, attitude, orientation, or any other characteristic that suggests replacement of the drone 105A would be desirable or prudent.

The drone 105C can alternatively, or additionally, determine that it is to replace the drone 105A by receiving a communication from the drone 105B. For example, the drone 105B can observe and/or communicate with the drone 105A to determine whether the drone 105A should be replaced. As a specific example, the drone 105B might lose communication with the drone 105A, in which case the operation to manipulate the payload 10 could be jeopardized. In response to detecting a loss of communication with the drone 105A, the drone 105B can communicate with the drone 105C to initiate replacement of the drone 105A. Alternatively, or in addition, the drone 105B can initiate replacement of the drone 105A in response to a detected change in its own position relative to the payload 10. Alternatively, or in addition, the drone 105B can initiate replacement of the drone 105A in response to a detected change in the position of the drone 105A relative to the payload 10. Alternatively, or in addition, the drone 105B can initiate replacement of the drone 105A in response to a detected change in the proportion of the weight of the payload 10 it is supporting. Generally speaking, the drone 105B can initiate replacement of the drone 105A in response to any observed change that indicates the drone 105A should be replaced by the drone 105C, such as a change in altitude, attitude, and/or orientation of the drone 105A, the drone 105B, and/or the payload 10.

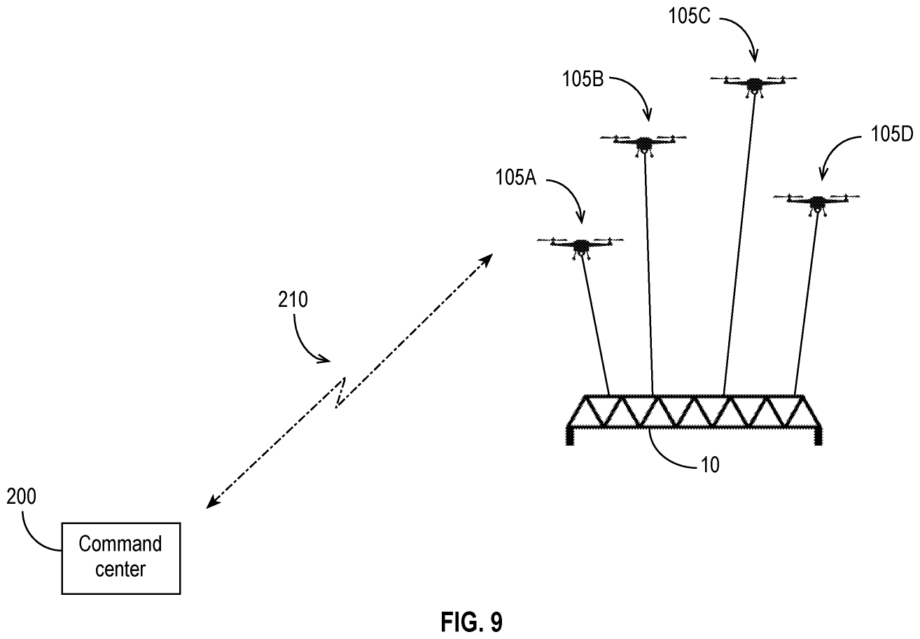

In some embodiments, the UAV system 100 includes a command center 200, as discussed further below in the discussion of FIG. 9, and the drone 105C alternatively, or additionally, determines that it is to replace the drone 105A by receiving a communication from the command center 200.

The drone 105A can determine that the drone 105C has attached to the payload 10 in any suitable way. For example, the drone 105C can emit a signal that informs the drone 105A that the drone 105C is attached to the payload 10. Alternatively, or in addition, the drone 105B can inform the drone 105A that the drone 105C has attached to the payload 10. For example, the drone 105B can observe the drone 105C attaching to the payload 10 and then send a signal to the drone 105A to report the attachment. Alternatively, or in addition, the drone 105A can determine that the drone 105C has attached to the payload 10 by detecting a change in a proportion of the weight of the payload 10 that is being supported by the drone 105A. For example, the drone 105A may detect that its load has decreased, and it may conclude that the drone 105C must have attached to the payload 10 and is supporting some of the weight of the payload 10. Alternatively, or in addition, the drone 105A can determine that the drone 105C has attached to the payload 10 by detecting its presence. For example, the drone 105A may be equipped with an on-board system (e.g., an optical system (e.g., a camera), sensors, a radar system, a LiDAR system, etc.) that allows it to detect the presence of the drone 105C. Alternatively, or in addition, in embodiments in which the UAV system 100 includes a command center 200, the drone 105A can determine that the drone 105C has attached to the payload 10 based on a communication received from the command center 200.

In embodiments in which the drones 105 in a UAV system 100 can be replaced by other drones 105 (e.g., with fresher batteries), regardless of whether the “new” drones 105 attach at the same (FIGS. 6B and 6C) or different (FIGS. 6D and 6E) attachment points 106 as the “old” drones 105, the individual drones 105 in the UAV system 100 can communicate to adapt to the changes to the characteristics of the drones 105 in the UAV system 100 and/or attachment points 106 to minimize or prevent disruption to the lift/transport mission. Specifically, the drones 105 in the UAV system 100 can adjust their operation (e.g., direction, speed, thrust, etc.) to adapt to the modified configuration (e.g., with the drone 105C and without the drone 105A). For example, the drone 105C can use a first set of flight settings (e.g., thrust, direction, etc.) while the drone 105A remains attached to the payload 10, and then use a second set of flight settings after the drone 105A detaches. As a specific example, the drone 105C can use a first thrust level while the drone 105A is still attached to the payload 10 and a second, higher thrust level after the drone 105A detaches. As another example, the drone 105C can use a first thrust direction while the drone 105A is still attached to the payload 10 and a second, different thrust direction after the drone 105A detaches. Similarly, the drones 105 in the UAV system 100 not involved in the replacement (e.g., drone 105B in the example above) can maintain stability of the payload 10 when (a) only drone 105A is attached (before drone 105C is attached), (b) both drone 105A and drone 105C are attached, and (c) only drone 105C is attached (after drone 105A has detached). For example, the drones 105 in the UAV system 100 that are not involved in the replacement of other drones 105 can change their thrust vectors and/or attachment points to maintain stability of the payload 10 during the replacement process.

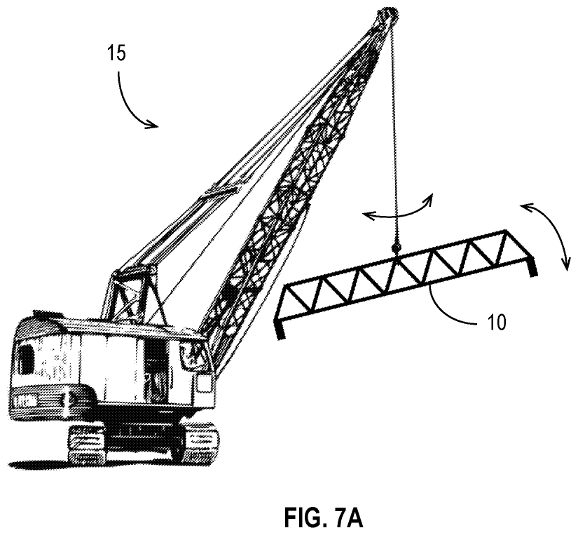

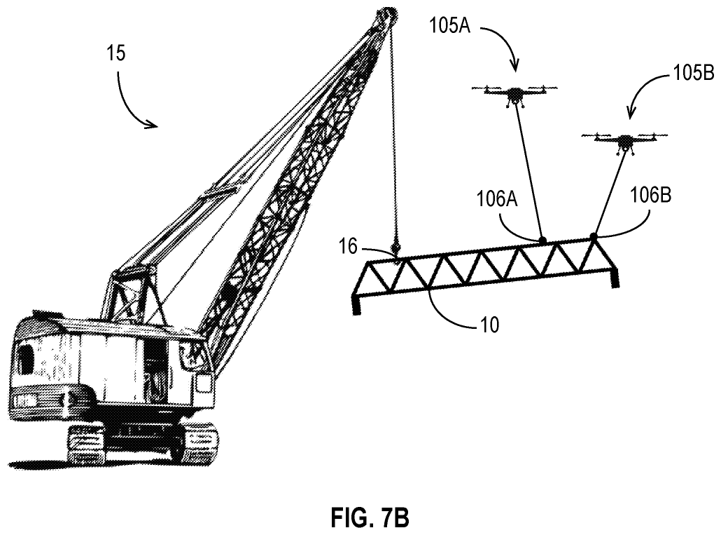

A UAV system 100 can also include other components, such as ground-based components. For example, the drones 105 in a UAV system 100 can coordinate with another component to provide lift and manipulation of payloads. FIGS. 7A and 7B illustrate an example of a configuration in which a UAV system 100 can be used to augment another component in accordance with some embodiments. FIG. 7A illustrates a crane 15 that is lifting a payload 10, shown as a truss, without any assistance from a UAV system 100. As indicated by the bidirectional arrows in FIG. 7A, the payload 10 can swing and/or rotate when only the crane 15 is used.

FIG. 7B illustrates how a UAV system 100 can be used to assist the crane 15 in lifting and maneuvering the payload 10. The example of a UAV system 100 shown in FIG. 7B includes the drone 105A and drone 105B, but it is to be appreciated that a UAV system 100 used to augment the capabilities of a ground-based component (e.g., a crane 15) can include any number of drones 105. The crane 15 is attached to the payload 10 at an attachment point 16. The drone 105A is attached to the payload 10 at the first attachment point 106A, and the drone 105B is attached to the payload 10 at the second attachment point 106B.

The attachment points of the crane 15, the drone 105A, and/or the drone 105B (and any additional drones 105 in the lift team) can be selected in any suitable manner. For example, the attachment point 16 of the crane 15 can be selected to be at any suitable or convenient location on the payload 10, and then the drone 105A and the drone 105B can determine the appropriate locations for the first attachment point 106A and the second attachment point 106B to provide the desired level and type of assistance (e.g., the drone 105A and drone 105B might select one set of attachment points 106 if the payload 10 is to be rotated during the mission and a second set of attachment points 106 if the orientation of the payload 10 is to remain largely the same during the flight). Although FIG. 7B illustrates the first attachment point 106A being in a different location than the second attachment point 106B, the drone 105A and the drone 105B can alternatively attach to the payload 10 at the same attachment point 106 (e.g., the first attachment point 106A, the second attachment point 106B, or a different attachment point 106). It will be appreciated that the appropriate configuration may depend on a number of factors, such as, for example, the characteristics (e.g., capabilities) of the drones 105 in the UAV system 100 and/or the crane 15 and/or the payload 10 and/or the objectives of the mission (e.g., whether the orientation of the payload 10 will be deliberately modified during flight, such as to move a wall segment from horizontal to vertical).

FIG. 7B is just one example of a configuration in which the drones 105 of a UAV system 100 assist another component to maneuver a payload 10. It is to be appreciated that many other applications and configurations are possible. For example, a team of drones 105 of a UAV system 100 could also be used with components such as weather balloons, etc. Coordination software executed by the drones 105 (and/or an external entity, such as a component (e.g., crane 15, weather balloon, etc.) being assisted by the drones 105) can allow the drones 105 to communicate not only among themselves, but also with other components (e.g., construction equipment, etc.) to provide new, augmented, and/or more flexible lifting and/or maneuvering capabilities.

In some embodiments, power and/or one or more wired communication channels can be provided by a component being assisted by the drones 105 of a UAV system 100. FIG. 8 illustrates an example of such a configuration in accordance with some embodiments. FIG. 8 shows drones 105 of a UAV system 100 (namely, drone 105A and drone 105B) coordinating with a crane 15 that provides power and/or communication to the drone 105A and the drone 105B via cables. In the illustrated example, the cable 120A runs from the crane 15 to an attachment point 16 on the payload 10 (e.g., at the location where the crane 15 attaches to the payload 10). In the example illustrated in FIG. 8, cables extend from the attachment point 16 across the top of the payload 10 to the attachment points 106 of the drones 105. Specifically, a cable 120B extends from the attachment point 16 to the first attachment point 106A, and a cable 120C extends from the attachment point 16 to the second attachment point 106B. The cable 120A and cable 120B can be used to provide power to and/or communication with the drone 105A, and the cable 120A and cable 120C can be used to provide power to and/or communication with the drone 105B. Because, in the configuration of FIG. 8, the crane 15 provides continuous power to the drone 105A and the drone 105B, the drones 105 can theoretically run “forever” and work with the crane 15 to provide not only additional lift, but also manipulation of the payload 10 that provides finer and more precise control of the payload 10 than the crane 15 would be able to provide on its own. As a result, because of the use of the drones 105 of a UAV system 100, the crane 15 is able to more accurately maneuver and/or place the payload 10 than it would be able to without the assistance of the drones 105. Such capabilities can be useful in a number of applications. For example, in a construction setting, heavy elements such as roof trusses, beams, wall segments, countertops, and the like can be maneuvered and placed safely without (or with less) human assistance and without concerns about battery failure of the drones 105.

It is to be appreciated that, as stated above, the power cables (e.g., cable 120A, cable 120B, cable 120C, etc.), if provided, can also be used by the drones 105 to communicate with each other and potentially with the crane 15 (or other connected device).

As explained above, one benefit of the UAV system 100 described herein is that the drones 105 can adjust one or more of their characteristics in response to detecting a change in a characteristic of the payload 10 they are maneuvering. For example, a drone 105A coupled to the payload 10 can detect a change in a characteristic of the payload 10 (e.g., its center of gravity, orientation, weight, shape, one of its dimensions, an oscillation frequency, etc.). The drone 105A can then send or receive a communication (e.g., over one or more of Bluetooth, Wi-Fi, infrared, radio-frequency (RF), a wireless connection, a wired connection) concerning an adjustment to be made to a characteristic of the drone 105A (e.g., a thrust, a power setting, an orientation, a speed, a direction, an altitude, an attitude, a propeller speed, a propeller orientation, a position relative to the payload, a position relative to another drone 105, a connection to the payload 10, a first attachment point 106A of the payload 10, a communication frequency, a communication technology, etc.) in response to the change in the payload characteristic. The drone 105A can the adjust its characteristic in accordance with the communication.

In some embodiments, the communication sent or received by the drone 105A is sent by the drone 105A to another drone 105B (e.g., to inform the drone 105B of a change to be made by the drone 105A, to inform the drone 105B of a change to be made by the drone 105B, to inform the drone 105B of the detected change in the characteristic of the payload 10, etc.). In some embodiments, the communication informs the drone 105B of a change to be made by the drone 105A, and the drone 105A waits to receive an acknowledgment from the drone 105B before adjusting its characteristic. Thus, the drone 105A and drone 105B can coordinate with each other to ensure that they do not make changes without informing each other and ensuring that the changes are acceptable to each other.

In some embodiments, the communication sent by the drone 105A indicates a delay that the drone 105A will allow to elapse before making the change to its characteristic. Communicating a delay to the drone 105B allows the drone 105B to prepare for the adjustment to the drone 105A's characteristic and/or schedule a modification to one or more of its own characteristics to compensate for the modification that will be made by the drone 105A. The drone 105A then implements the adjustment to its characteristic in accordance with the delay indicated in the communication sent to the drone 105B. In some embodiments, the drone 105A and the drone 105B (and any other drones 105 in the UAV system 100) follow a convention for the implementation of changes, such as delaying the implementation of all changes by a specified amount of time (e.g., 1 second, 5 seconds, etc.).

In some embodiments, the communication sent by the drone 105A instructs the drone 105B to adjust at least one of its characteristics (e.g., a thrust, a power setting, an orientation, a speed, a direction, an altitude, an attitude, a propeller speed, a propeller orientation, a position relative to the payload, a position relative to another drone 105, a connection to the payload 10, a first attachment point 106A of the payload 10, a communication frequency, a communication technology, etc.). The communication can also include a

In some embodiments, the communication sent or received by the drone 105A is from another drone 105B. In some embodiments, the drone 105A sends an acknowledgment of the communication to the drone 105B and adjusts the characteristic of the drone 105A after sending the acknowledgment. In some embodiments, the communication from the drone 105B instructs the drone 105A to wait for a specified amount of time before adjusting its characteristic. The communication can specify the amount of time to wait (e.g., a delay), or the drone 105A and the drone 105B can have a preexisting agreement to delay all changes by a particular amount of time.

In some embodiments, the UAV system 100 includes, in addition to the drones 105, a command center that is able to communicate with (e.g., over one or more of Bluetooth, Wi-Fi, infrared, radio-frequency (RF), a wireless connection, a wired connection) some or all of the drones 105 in the UAV system 100. FIG. 9 is an illustration of a UAV system 100 that includes a command center 200 in accordance with some embodiments. As shown in FIG. 9, the command center 200 is capable of communicating with one or more of the drones 105 (illustrated by the signals 210 in FIG. 9). In some embodiments that include a command center 200, a drone 105A coupled to the payload 10 detects a change in a characteristic of the payload 10 (e.g., its center of gravity, orientation, weight, shape, one of its dimensions, an oscillation frequency, etc.) and sends a communication to, or receives a communication from, the command center concerning an adjustment to be made to a characteristic of the drone 105A (e.g., a thrust, a power setting, an orientation, a speed, a direction, an altitude, an attitude, a propeller speed, a propeller orientation, a position relative to the payload, a position relative to another drone 105, a connection to the payload 10, a first attachment point 106A of the payload 10, a communication frequency, a communication technology, etc.) in response to the change in the payload characteristic. The drone 105A can the adjust its characteristic in accordance with the communication.

In some embodiments that include a command center 200, the drone 105A sends a communication to the command center 200, and the command center 200 sends an acknowledgment to the drone 105A. The drone 105A then adjusts its characteristic after receiving the acknowledgment from the command center 200. In some embodiments, the communication indicates an implementation delay, and the drone 105A waits to adjust its characteristic until the implementation delay has elapsed. In other embodiments, the drone 105A waits until a specified amount of time has elapsed before adjusting its characteristic. The specified amount of time can be prearranged or provided in the communication from the drone 105A.

In some embodiments, the drone 105A conveys information about other drones 105 in the UAV system 100 to the command center 200. For example, the drone 105A can send information to the command center 200 about an adjustment the drone 105B will make to one or more of its characteristics (e.g., a thrust, a power setting, an orientation, a speed, a direction, an altitude, an attitude, a propeller speed, a propeller orientation, a position relative to the payload, a position relative to another drone 105, a connection to the payload 10, a first attachment point 106A of the payload 10, a communication frequency, a communication technology, etc.). In some embodiments, the communication indicates that the drone 105B will delay its adjustment for a specified amount of time. The specified amount of time can be prearranged or provided in the communication from the drone 105A.

In some embodiments that include a command center 200, the command center 200 sends a communication to the drone 105A. In some embodiments, the drone 105A responds by sending an acknowledgment to the command center 200 before it adjusts its characteristic. In some embodiments, the communication instructs the drone 105A to wait for a specified amount of time to elapse before adjusting its characteristic, and the drone 105A waits for the specified amount of time to elapse before adjusting its characteristic.

In some embodiments that include a command center 200, the drone 105A acts as an intermediary between the other drones 105 of the UAV system 100 and the command center 200. For example, the command center 200 can send a communication to the drone 105A. The communication can instruct the drone 105A to instruct the drone 105B to make an adjustment to one or more of its characteristics (e.g., a thrust, a power setting, an orientation, a speed, a direction, an altitude, an attitude, a propeller speed, a propeller orientation, a position relative to the payload, a position relative to a second drone, a connection to the payload, a connection point of the payload, a communication frequency, a communication technology, etc.) in response to the change in the payload characteristic. In response, the drone 105A can communicate with the drone 105B (e.g., by sending a message to the drone 105B) regarding the adjustment the drone 105B is supposed to make. The drone 105B can then adjust its characteristic(s) in accordance with the communication from the drone 105A. In some embodiments, the drone 105B sends a confirmation to the drone 105A to acknowledge the adjustment to the drone 105B's characteristic, and the drone 105A notifies the command center 200 that the drone 105B acknowledged the adjustment to its characteristic.

In some embodiments that include a command center 200, the command center 200 communicates with one or more of the drones 105 over a first wireless network, and the drones 105 communicate with each other over a second wireless network. For example, the first wireless network may be a Wi-Fi or cellular network, and the second wireless network may include one or more of infrared, optical, Bluetooth, or radio-frequency (RF) communication.

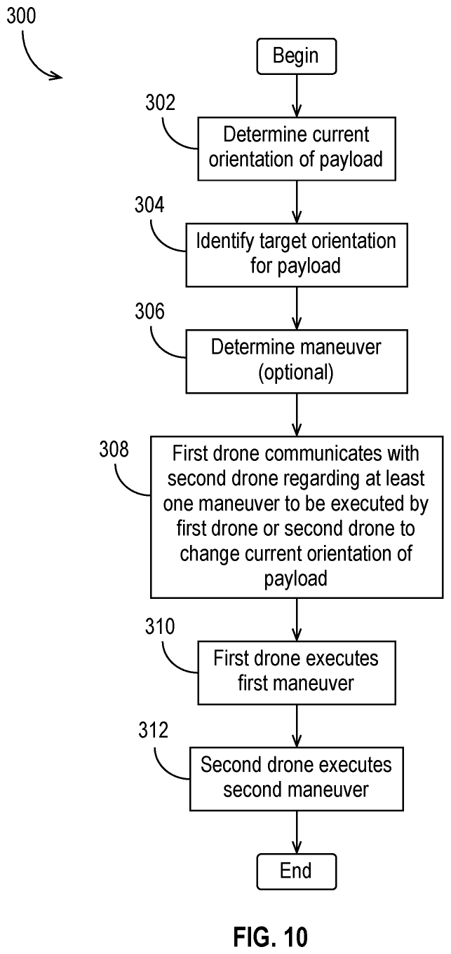

FIG. 10 is a flow diagram of a method 300 that can be performed by the drones 105 of a UAV system 100 in accordance with some embodiments. At block 302, one or more of the drones 105 determine a current orientation of a payload 10. The drones 105 may already be connected to the payload 10, or the payload 10 may be awaiting pickup by the drones 105. The drones 105 may determine the current orientation of the payload 10 by, for example, at least one drone of the plurality of drones 105 receiving from a command center 200 a signal that conveys the current orientation of the payload 10. The signal may comprise, for example, a Bluetooth, Wi-Fi, cellular, Zigbee, radio-frequency, infrared, wireless, or wired signal. The signal may also convey other information about the payload 10, such as, for example, the current location of the payload 10. At least one drone of the drones 105 may process (e.g., decode, analyze, etc.) the signal to extract information from the signal.

In some embodiments, one or more of the drones 105 determine the current orientation of the payload 10 at block 302 by at least one of the drones 105 receiving a signal from the payload 10. The signal may comprise, for example, a Bluetooth, Wi-Fi, cellular, Zigbee, radio-frequency, infrared, wireless, or wired signal. The signal from the payload 10 may, for example, convey the current orientation and/or location of the payload 10. At least one drone of the drones 105 may then process (e.g., decode, analyze, etc.) the signal from the payload 10 to determine the current orientation of the payload 10.

In some embodiments, one or more of the drones 105 determine the current orientation of the payload 10 by using an on-board component (e.g., an optical camera, a sonar system, a LiDAR system, a radar system, etc.) to detect the current orientation of the payload 10. The payload 10 may include markers (e.g., stickers, reflectors, QR codes, patterns, etc.) that can be detected by the on-board component(s) of the drones 105.

At block 304, one or more of the drones 105 identify a target orientation for the payload 10. For example, one or more of the drones 105 may determine that the payload 10 should be rotated about an axis (which could be any arbitrary axis, and not necessarily a horizontal or vertical axis), or raised or lowered, or subjected to any other modification to change its orientation. In some embodiments, the one or more drones 105 identify the target orientation for the payload 10 by receiving from a command center 200 a signal that conveys the target orientation of the payload 10. The signal may comprise, for example, a Bluetooth, Wi-Fi, cellular, Zigbee, radio-frequency, infrared, wireless, or wired signal. The signal may also convey other information about the payload 10, such as, for example, a target location for the payload 10. At least one drone of the drones 105 may process (e.g., decode, analyze, etc.) the signal to extract information from the signal.

In some embodiments, one or more of the drones 105 determine the target orientation of the payload 10 at block 304 by at least one of the drones 105 receiving a signal from the payload 10. The signal may comprise, for example, a Bluetooth, Wi-Fi, cellular, Zigbee, radio-frequency, infrared, wireless, or wired signal. The signal from the payload 10 may, for example, convey the target orientation of the payload 10 and/or other information about the payload 10 or the destination of the payload 10 (e.g., where the payload 10 is being transported). At least one drone of the drones 105 may process (e.g., decode, analyze, etc.) the signal from the payload 10 to extract information from the signal (e.g., the target orientation of the payload 10, the target location of the payload 10, etc.).

In some embodiments, one or more of the drones 105 identify the target orientation of the payload 10 by analyzing the scene and, based at least in part on the analysis, determining the target orientation for the payload 10. For example, if the payload 10 is a wall segment or a roof truss lying flat on the ground between two skyscrapers, the one or more of the drones 105 may analyze the scene and detect the presence of the skyscrapers. The one or more drones 105 can then determine that the payload 10 would be more safely transported in the scene if it were rotated about a horizontal axis into a vertical position as opposed to being moved while flat. In some embodiments, the scene is represented by a three-dimensional map. The one or more drones 105 can take into account the map or any other information that helps them determine a suitable target orientation for the payload 10. Such information may include, for example, weather conditions (e.g., wind speed, wind direction, humidity, rain, etc.), obstacles in the scene that could be problematic when the payload 10 is moved, expected changes to the payload 10 while in flight, capabilities (power, battery level, size, weight, thrust, etc.) of one or more of the drones 105 in the UAV system 100, etc.

Optionally, at block 306, a drone 105A of the plurality of drones 105 determines at least one maneuver to be executed by the drone 105A or another drone 105B of the plurality of drones 105 in order to change the current orientation of the payload 10. Alternatively, at optional block 306, the drone 105A and the drone 105B cooperate to determine the at least one maneuver to be executed by the drone 105A or another drone 105B of the plurality of drones 105 in order to change the current orientation of the payload 10. The drone 105A and the drone 105B can cooperate through one of the drones 105 collecting information from the other (e.g., the drone 105A collecting information from the drone 105B). The collected information can include, for example, an indication of a capability of the drone 105B (e.g., power, size, speed, propeller span, etc.), a make of the drone 105B, a model of the drone 105B, a battery level of the drone 105B, a maximum thrust of the drone 105B, a size of the drone 105B, or an attachment capability (e.g., ways the drone 105B is able to attach to the payload 10) of the drone 105B. The determination of the at least one maneuver may be based on, for example, the current orientation of the payload 10, a size of the payload 10, a weight of the payload 10, a dimension of the payload 10, a volume of the payload 10, one or more attachment points 106 on the payload 10, a capability of the drone 105A, a capability of the drone 105B, an aggregate capability of the plurality of drones 105, a number of available drones 105 in the plurality of drones 105, a total number of drones 105 in the plurality of drones 105, a flight path, a topography of a region, a position of an obstacle, a weather condition, an expected change to a characteristic of the payload 10 (e.g., a change in the weight, size, shape, dimension, volume, center of gravity, oscillation frequency induced by the payload 10, etc.), a time constraint, an amount of time, and/or an analysis of a scene.

At block 308, the drone 105A communicates with (e.g., sends a signal to and/or receives a signal from) the drone 105B regarding the at least one maneuver to be executed by the drone 105A or another drone 105B of the plurality of drones 105 in order to change the current orientation of the payload 10. The at least one maneuver may involve a change in the drone 105A's or drone 105B's thrust, power setting, orientation, speed, direction, altitude, attitude, propeller speed, propeller orientation, position relative to the payload, position relative to another drone of the plurality of drones 105, connection to the payload 10, and/or attachment point 106 on the payload 10. The communication can comprise, for example, at least one of a Bluetooth, Wi-Fi, cellular, Zigbee, radio-frequency, infrared, wireless, or wired signal.

At block 310, the drone 105A executes a first maneuver, and at block 312 the drone 105B executes a second maneuver. One or both of the first maneuver and/or the second maneuver may have been the subject of the communication at block 308. The first maneuver and/or the second maneuver can be characterized by, for example, a speed, a direction, a thrust, a velocity, an angle, a delay, a start time, a completion time, and/or a duration. After the first maneuver and the second maneuver, the payload 10 has a new (modified) orientation that is substantially the target orientation.

For simplicity, the drawings herein show a small number of drones 105 (e.g., two or three), but it is to be appreciated that any number of drones 105 can be used in a UAV system 100. Different applications will likely call for different numbers of drones 105. One of the advantages of the disclosed embodiments is scalability. An appropriate number of drones 105 can be selected and configured as described herein to provide the desired lifting and/or maneuvering capabilities.

In the foregoing description and in the accompanying drawings, specific terminology has been set forth to provide a thorough understanding of the disclosed embodiments. In some instances, the terminology or drawings may imply specific details that are not required to practice the invention.

To avoid obscuring the present disclosure unnecessarily, well-known components are shown in block diagram form and/or are not discussed in detail or, in some cases, at all.

Unless otherwise specifically defined herein, all terms are to be given their broadest possible interpretation, including meanings implied from the specification and drawings and meanings understood by those skilled in the art and/or as defined in dictionaries, treatises, etc. As set forth explicitly herein, some terms may not comport with their ordinary or customary meanings.

As used herein, the singular forms “a,” “an” and “the” do not exclude plural referents unless otherwise specified. The word “or” is to be interpreted as inclusive unless otherwise specified. Thus, the phrase “A or B” is to be interpreted as meaning all of the following: “both A and B,” “A but not B,” and “B but not A.” Any use of “and/or” herein does not mean that the word “or” alone connotes exclusivity.

As used herein, phrases of the form “at least one of A, B, and C,” “at least one of A, B, or C,” “one or more of A, B, or C,” and “one or more of A, B, and C” are interchangeable, and each encompasses all of the following meanings: “A only,” “B only,” “C only,” “A and B but not C,” “A and C but not B,” “B and C but not A,” and “all of A, B, and C.”

To the extent that the terms “include(s),” “having,” “has,” “with,” and variants thereof are used herein, such terms are intended to be inclusive in a manner similar to the term “comprising,” i.e., meaning “including but not limited to.”

The terms “exemplary” and “embodiment” are used to express examples, not preferences or requirements. The term “coupled” is used herein to express a direct connection/attachment as well as a connection/attachment through one or more intervening elements or structures.

The terms “over,” “under,” “between,” and “on” are used herein refer to a relative position of one feature with respect to other features. For example, one feature disposed “over” or “under” another feature may be directly in contact with the other feature or may have intervening material. Moreover, one feature disposed “between” two features may be directly in contact with the two features or may have one or more intervening features or materials. In contrast, a first feature “on” a second feature is in contact with that second feature.

The term “substantially” is used to describe a structure, configuration, dimension, etc. that is largely or nearly as stated, but, due to manufacturing tolerances and the like, may in practice result in a situation in which the structure, configuration, dimension, etc. is not always or necessarily precisely as stated. For example, describing two lengths as “substantially equal” means that the two lengths are the same for all practical purposes, but they may not (and need not) be precisely equal at sufficiently small scales. As another example, a structure that is “substantially vertical” would be considered to be vertical for all practical purposes, even if it is not precisely at 90 degrees relative to horizontal.

The drawings are not necessarily to scale, and the dimensions, shapes, and sizes of the features may differ substantially from how they are depicted in the drawings.

Although specific embodiments have been disclosed, it will be evident that various modifications and changes may be made thereto without departing from the broader spirit and scope of the disclosure. For example, features or aspects of any of the embodiments may be applied, at least where practicable, in combination with any other of the embodiments or in place of counterpart features or aspects thereof. Accordingly, the specification and drawings are to be regarded in an illustrative rather than a restrictive sense.

1. An unmanned aerial vehicle (UAV) system, comprising:
a plurality of drones capable of communicating with each other to conduct a coordinated maneuver of a payload coupled to the plurality of drones, the plurality of drones including a first drone configured to:
detect a change in a payload characteristic of the payload;
send or receive a communication, wherein the communication concerns an adjustment to be made to a drone characteristic of the first drone in response to the change in the payload characteristic; and
adjust the drone characteristic in accordance with the communication.

2-26. (canceled)

27. A method performed by a drone lift team comprising a plurality of drones, the method comprising:
determining a current orientation of a payload;
identifying a target orientation for the payload;
a first drone of the plurality of drones communicating with a second drone of the plurality of drones regarding at least one maneuver to be performed by the first drone or the second drone to change the current orientation of the payload, the at least one maneuver including at least one of a first maneuver to be executed by the first drone or a second maneuver to be executed by the second drone;
the first drone executing the first maneuver; and
the second drone executing the second maneuver;
wherein, after the first maneuver and after the second maneuver, a modified orientation of the payload is substantially the target orientation.

28-56. (canceled)

57. An unmanned aerial vehicle (UAV) system for manipulating a payload, the UAV system comprising:
a first drone capable of being attached to the payload;
a second drone capable of being attached to the payload and configured to communicate with the first drone to conduct a coordinated operation to manipulate the payload; and
a third drone capable of being attached to the payload and configured to communicate with the first drone and the second drone, wherein the third drone is configured to:
determine that the third drone will replace the first drone during the coordinated operation to manipulate the payload, and
in response to determining that the third drone will replace the first drone during the coordinated operation to manipulate the payload, attach to the payload at a selected attachment point,
and wherein the first drone is configured to:
determine that the third drone is attached to the payload, and
in response to determining that the third drone is attached to the payload, detach from the payload.

58. (canceled)

59. The UAV system recited in claim 57, wherein the selected attachment point differs from an attachment point used by the first drone.

60. The UAV system recited in claim 57, wherein the third drone is configured to determine that the third drone will replace the first drone during the coordinated operation to manipulate the payload based on a communication received from the first drone.

61. The UAV system recited in claim 60, wherein the communication concerns a power level of the first drone.

62. The UAV system recited in claim 57, wherein the third drone is configured to determine that the third drone will replace the first drone during the coordinated operation to manipulate the payload based on an observation of a characteristic of the first drone and/or the second drone and/or the payload.

63. The UAV system recited in claim 62, wherein the characteristic is at least one of an altitude, an attitude, or an orientation.

64. The UAV system recited in claim 62, wherein the third drone is configured to use an on-board optical system to make the observation.

65. The UAV system recited in claim 57, wherein the third drone is configured to determine that the third drone will replace the first drone during the coordinated operation to manipulate the payload based on a communication received from the second drone.

66. The UAV system recited in claim 65, wherein the communication received from the second drone includes an indication of an observation made by the second drone.

67. The UAV system recited in claim 66, wherein the observation made by the second drone comprises a detected change in a position of the second drone relative to the payload.

68. The UAV system recited in claim 66, wherein the observation made by the second drone comprises a detected change in at least one of:
a position of the first drone relative to the payload,
a proportion of a weight of the payload being supported by the second drone,
an altitude, attitude, and/or orientation of the first drone, the second drone, and/or the payload.

69-70. (canceled)

71. The UAV system recited in claim 65, wherein the second drone is configured to send the communication to the third drone after detecting a loss of communication with the first drone.

72. The UAV system recited in claim 57, further comprising a command center, and wherein the third drone is configured to determine that the third drone will replace the first drone during the coordinated operation to manipulate the payload based on a communication received from the command center.

73. The UAV system recited in claim 57, wherein the first drone is configured to determine that the third drone is attached to the payload based on a signal received from the third drone or from the second drone.

74. (canceled)

75. The UAV system recited in claim 57, wherein the first drone is configured to determine that the third drone is attached to the payload based at least in part on a detected change in a proportion of a weight of the payload being supported by the first drone.

76. The UAV system recited in claim 57, wherein the first drone is configured to determine that the third drone is attached to the payload by detecting a presence of the third drone.

77. The UAV system recited in claim 76, wherein the first drone comprises an on-board optical system, and wherein the first drone is configured to detect the presence of the third drone using the on-board optical system.

78. The UAV system recited in claim 57, further comprising a command center, and wherein the first drone is configured to determine that the third drone is attached to the payload based on a communication received from the command center.

79. The UAV system recited in claim 57, wherein the first drone is further configured to navigate to a base after detaching from the payload.

80. The UAV system recited in claim 57, wherein the third drone is further configured to:
use first flight settings after attaching to the payload at the selected attachment point, and
use second flight settings after the first drone has detached from the payload.

81. The UAV system recited in claim 80, wherein:
the first flight settings include a first thrust level, and the second flight settings include a second thrust level, wherein the second thrust level provides more thrust than the first thrust level, and/or
the first flight settings include a first thrust direction, and the second flight settings include a second thrust direction, wherein the first thrust direction and the second thrust direction are different.

82. (canceled)
